(19) United States
(12) Patent Application Publication
(10) Pub. No.: US 2024/0257307 A1
(43) Pub. Date: Aug. 1, 2024

(54) HISTOGRAM BASED AR/MR OBJECT IMAGE EDGE SHARPENING/ENHANCEMENT

(71) Applicant: QUALCOMM Incorporated, San Diego, CA (US)

(72) Inventors: Hitesh Venkata RACHAKONDA, Hyderabad (IN); Ankita CHAUDHA, Hyderabad (IN); Sridhar Rao NUNE, Hyderabad (IN)

(21) Appl. No.: 18/163,227

(22) Filed: Feb. 1, 2023

(51) Int. Cl. G06T 5/40; G06T 5/00; G06T 7/13

(52) U.S. Cl. CPC G06T 5/40; G06T 5/73; G06T 7/13

(57) ABSTRACT

This disclosure provides systems, devices, apparatus, and methods, including computer programs encoded on storage media, for histogram based AR/MR object image edge sharpening/enhancement. A display processor may obtain an image of an environment captured by a camera and a frame that is to be displayed. The display processor may compute a first histogram based on the image and a second histogram based on the frame. The display processor may add noise to the frame based on the first histogram and the second histogram, where the noise is distinguishable from at least a portion of the image. The display processor may transmit the frame including the noise for display on a display device.

### TECHNICAL FIELD

The present disclosure relates generally to processing systems, and more particularly, to one or more techniques for display processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

Current techniques pertaining to extended reality (XR) displays may not sufficiently distinguish XR objects from real-world environments. There is a need for improved techniques for distinguishing XR objects from real-world environments.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for display processing are provided. The apparatus includes a memory and at least one processor coupled to the memory and, based at least in part on information stored in the memory, the at least one processor is configured to obtain an image of an environment captured by a camera and a frame that is to be displayed; compute a first histogram based on the image and a second histogram based on the frame; add noise to the frame based on the first histogram and the second histogram, where the noise is distinguishable from at least a portion of the image; and transmit the frame including the noise for display on a display device.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system in accordance with one or more techniques of this disclosure.

FIG. 2 illustrates an example graphics processor (e.g., a GPU) in accordance with one or more techniques of this disclosure in accordance with one or more techniques of this disclosure.

FIG. 3 illustrates an example display framework including a display processor and a display in accordance with one or more techniques of this disclosure.

FIG. 4 is a diagram illustrating example display processing unit (DPU) hardware for display processing in accordance with one or more techniques of this disclosure.

FIG. 5 is a diagram illustrating examples of display frames without and with added noise in accordance with one or more techniques of this disclosure.

FIG. 6 is a diagram illustrating examples of histograms in accordance with one or more techniques of this disclosure.

FIG. 7 is a diagram illustrating an example process for determining a match factor in accordance with one or more techniques of this disclosure.

FIG. 8 is a diagram illustrating an example process for determining whether noise is to be added to a display frame, determining an amount of the noise to be added to the display frame, and adding attenuation to the display frame in accordance with one or more techniques of this disclosure.

FIG. 9 is a diagram illustrating example aspects of a noise layer for adding noise to a display frame in accordance with one or more techniques of this disclosure.

FIG. 10 is a diagram illustrating example aspects of computing noise strength in accordance with one or more techniques of this disclosure.

FIG. 11 is a call flow diagram illustrating example communications between a DPU, GPU, and a display in accordance with one or more techniques of this disclosure in accordance with one or more techniques of this disclosure.

FIG. 12 is a flowchart of an example method of display processing in accordance with one or more techniques of this disclosure.

FIG. 13 is a flowchart of an example method of display processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

An augmented reality (AR) or a mixed reality (MR) device worn/utilized by a user may display a rendered object (i.e., an AR/MR object) on a display such that the AR/MR object is overlaid upon an image of environment in which the user is present or such that the AR/MR object is presented on a transparent or semi-transparent surface (e.g., glass) through which the user is viewing the environment. If a color tone of the environment is identical to or similar to a color tone of the AR/MR object, the AR/MR object may not be readily perceived by the user. For instance, if the AR/MR object is white and the user is in a room with white lighting, the AR/MR object may be difficult to perceive. This may hinder the experience of the user, as the user may not be able to differentiate the real-world from the AR/MR object. Furthermore, if a user is not able to differentiate the real-world from the AR/MR object, the AR/MR device may re-render the AR/MR object in a different color, which may be an inefficient use of computing resources.

Various technologies pertaining to histogram based AR/MR object image edge sharpening/enhancement are described herein. In an example, an apparatus may obtain an image of an environment captured by a camera and a frame that is to be displayed. The frame may include computer rendered content, such as one or more AR/MR objects. In some aspects, the frame may include only computer rendered content (i.e., no real-world content captured by a camera). The apparatus may compute a first histogram based on the image and a second histogram based on the frame. The apparatus may add noise to the frame based on the first histogram and the second histogram, where the noise is distinguishable from at least a portion of the image. The apparatus may transmit the frame including the noise for display on a display device. Vis-à-vis the aforementioned technologies, the apparatus may help to visually distinguish objects (e.g., AR objects, MR objects, etc.) from the environment (e.g., by adding the noise to or around edges of the objects) such that the objects may be readily perceived when displayed on the display device. Furthermore, the aforementioned technologies may prevent and/or reduce re-rendering of the objects, which may lead to more efficient use of computing resources of the apparatus.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

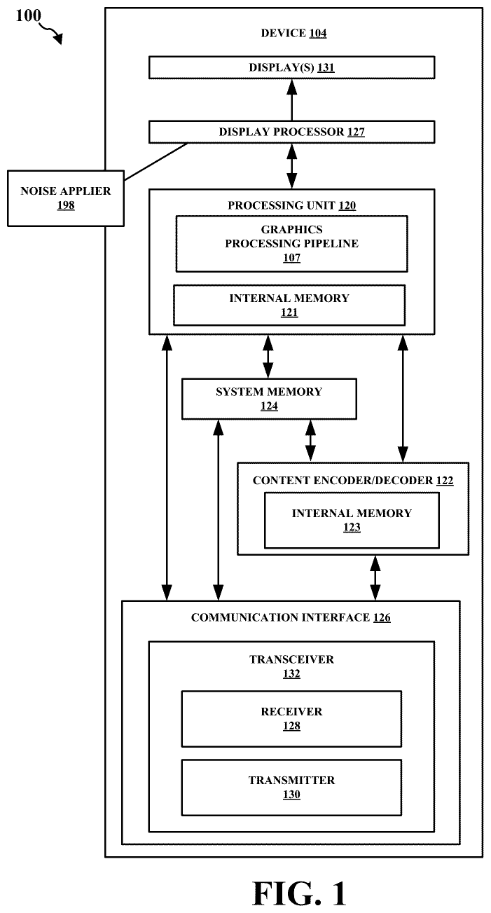

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the display processor 127 may include a noise applier 198 configured to obtain an image of an environment captured by a camera and a frame that is to be displayed; compute a first histogram based on the image and a second histogram based on the frame; add noise to the frame based on the first histogram and the second histogram, where the noise is distinguishable from at least a portion of the image; and transmit the frame including the noise for display on a display device. Although the following description may be focused on display processing, the concepts described herein may be applicable to other similar processing techniques. Furthermore, although the following description may be focused on augmented reality (AR), the concepts described herein may also be applicable to mixed reality (MR), as well as other types of XR technologies.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit or bits that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

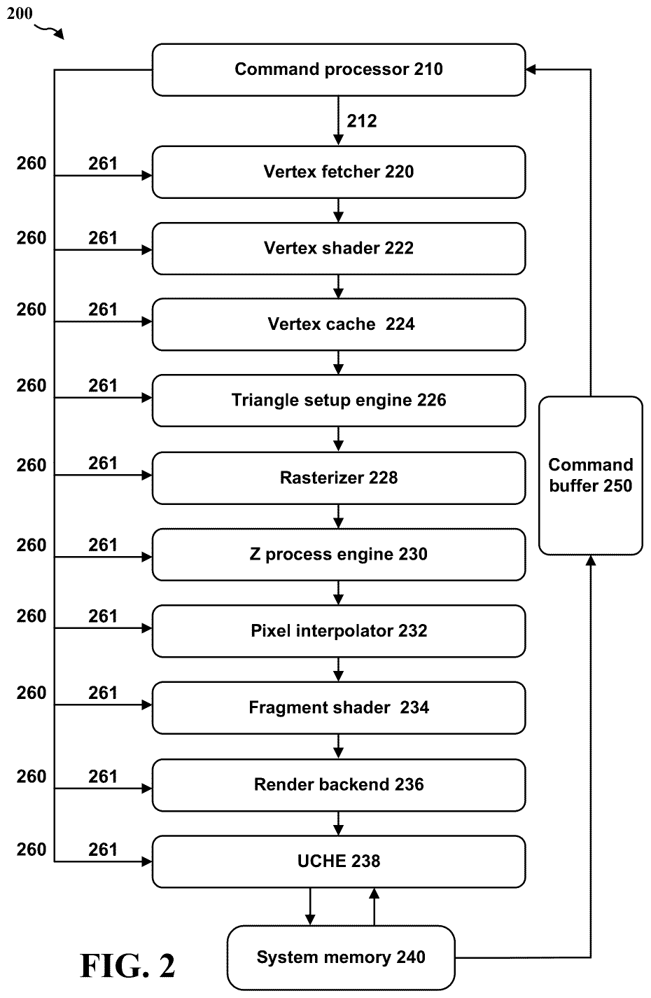

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, L2 cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can simultaneously store the following information: context register of context N, draw call(s) of context N, context register of context N+1, and draw call(s) of context N+1.

GPUs can render images in a variety of different ways. In some instances, GPUs can render an image using direct rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects of tiled rendering, during the binning pass, a visibility stream can be constructed where visible primitives or draw calls can be identified. A rendering pass may then be performed. In contrast to tiled rendering, direct rendering does not divide the frame into smaller bins or tiles. Rather, in direct rendering, the entire frame is rendered at a single time (i.e., without a binning pass). Additionally, some types of GPUs can allow for both tiled rendering and direct rendering (e.g., flex rendering).

In some aspects, GPUs can apply the drawing or rendering process to different bins or tiles. For instance, a GPU can render to one bin, and perform all the draws for the primitives or pixels in the bin. During the process of rendering to a bin, the render targets can be located in GPU internal memory (GMEM). In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible so that the non-visible primitives are not rendered, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a binning, a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory and used to remove primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

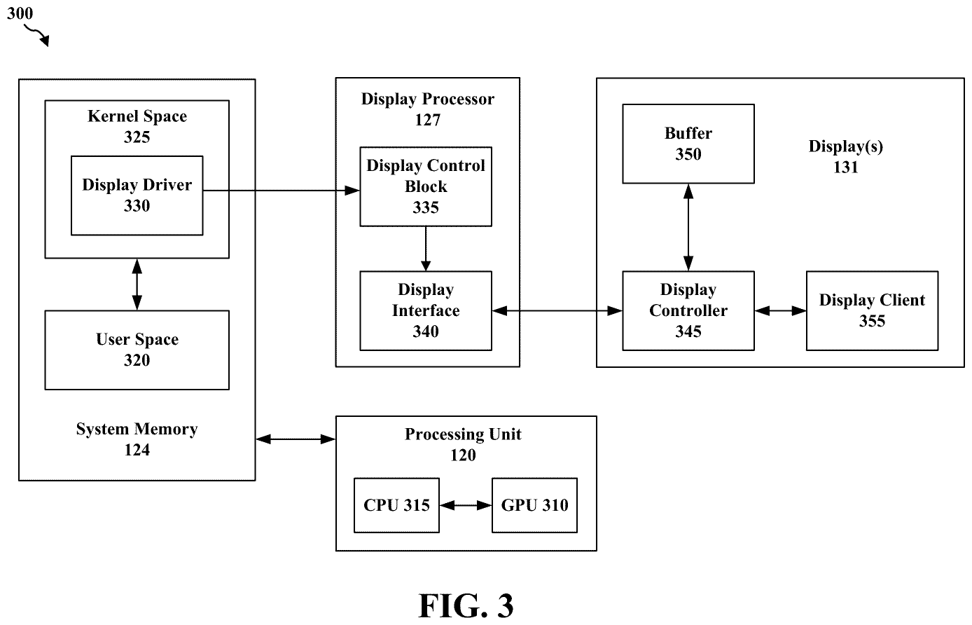

FIG. 3 is a block diagram 300 that illustrates an example display framework including the processing unit 120, the system memory 124, the display processor 127, and the display(s) 131, as may be identified in connection with the device 104.

A GPU may be included in devices that provide content for visual presentation on a display. For example, the processing unit 120 may include a GPU 310 configured to render graphical data for display on a computing device (e.g., the device 104), which may be a computer workstation, a mobile phone, a smartphone or other smart device, an embedded system, a personal computer, a tablet computer, a video game console, and the like. Operations of the GPU 310 may be controlled based on one or more graphics processing commands provided by a CPU 315. The CPU 315 may be configured to execute multiple applications concurrently. In some cases, each of the concurrently executed multiple applications may utilize the GPU 310 simultaneously. Processing techniques may be performed via the processing unit 120 output a frame over physical or wireless communication channels.

The system memory 124, which may be executed by the processing unit 120, may include a user space 320 and a kernel space 325. The user space 320 (sometimes referred to as an “application space”) may include software application(s) and/or application framework(s). For example, software application(s) may include operating systems, media applications, graphical applications, workspace applications, etc. Application framework(s) may include frameworks used by one or more software applications, such as libraries, services (e.g., display services, input services, etc.), application program interfaces (APIs), etc. The kernel space 325 may further include a display driver 330. The display driver 330 may be configured to control the display processor 127. For example, the display driver 330 may cause the display processor 127 to compose a frame and transmit the data for the frame to a display.

The display processor 127 includes a display control block 335 and a display interface 340. The display processor 127 may be configured to manipulate functions of the display(s) 131 (e.g., based on an input received from the display driver 330). The display control block 335 may be further configured to output image frames to the display(s) 131 via the display interface 340. In some examples, the display control block 335 may additionally or alternatively perform post-processing of image data provided based on execution of the system memory 124 by the processing unit 120.

The display interface 340 may be configured to cause the display(s) 131 to display image frames. The display interface 340 may output image data to the display(s) 131 according to an interface protocol, such as, for example, the MIPI DSI (Mobile Industry Processor Interface, Display Serial Interface). That is, the display(s) 131, may be configured in accordance with MIPI DSI standards. The MIPI DSI standard supports a video mode and a command mode. In examples where the display(s) 131 is/are operating in video mode, the display processor 127 may continuously refresh the graphical content of the display(s) 131. For example, the entire graphical content may be refreshed per refresh cycle (e.g., line-by-line). In examples where the display(s) 131 is/are operating in command mode, the display processor 127 may write the graphical content of a frame to a buffer 350.

In some such examples, the display processor 127 may not continuously refresh the graphical content of the display(s) 131. Instead, the display processor 127 may use a vertical synchronization (Vsync) pulse to coordinate rendering and consuming of graphical content at the buffer 350. For example, when a Vsync pulse is generated, the display processor 127 may output new graphical content to the buffer 350. Thus, generation of the Vsync pulse may indicate that current graphical content has been rendered at the buffer 350.

Frames are displayed at the display(s) 131 based on a display controller 345, a display client 355, and the buffer 350. The display controller 345 may receive image data from the display interface 340 and store the received image data in the buffer 350. In some examples, the display controller 345 may output the image data stored in the buffer 350 to the display client 355. Thus, the buffer 350 may represent a local memory to the display(s) 131. In some examples, the display controller 345 may output the image data received from the display interface 340 directly to the display client 355.

The display client 355 may be associated with a touch panel that senses interactions between a user and the display(s) 131. As the user interacts with the display(s) 131, one or more sensors in the touch panel may output signals to the display controller 345 that indicate which of the one or more sensors have sensor activity, a duration of the sensor activity, an applied pressure to the one or more sensor, etc. The display controller 345 may use the sensor outputs to determine a manner in which the user has interacted with the display(s) 131. The display(s) 131 may be further associated with/include other devices, such as a camera, a microphone, and/or a speaker, that operate in connection with the display client 355.

Some processing techniques of the device 104 may be performed over three stages (e.g., stage 1: a rendering stage; stage 2: a composition stage; and stage 3: a display/transfer stage). However, other processing techniques may combine the composition stage and the display/transfer stage into a single stage, such that the processing technique may be executed based on two total stages (e.g., stage 1: the rendering stage; and stage 2: the composition/display/transfer stage). During the rendering stage, the GPU 310 may process a content buffer based on execution of an application that generates content on a pixel-by-pixel basis. During the composition and display stage(s), pixel elements may be assembled to form a frame that is transferred to a physical display panel/subsystem (e.g., the displays 131) that displays the frame.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in doubled data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some aspects of display processing may utilize different types of mask layers, e.g., a shape mask layer. A mask layer is a layer that may represent a portion of a display or display panel. For instance, an area of a mask layer may correspond to an area of a display, but the entire mask layer may depict a portion of the content that is actually displayed at the display or panel. For example, a mask layer may include a top portion and a bottom portion of a display area, but the middle portion of the mask layer may be empty. In some examples, there may be multiple mask layers to represent different portions of a display area. Also, for certain portions of a display area, the content of different mask layers may overlap with one another. Accordingly, a mask layer may represent a portion of a display area that may or may not overlap with other mask layers.

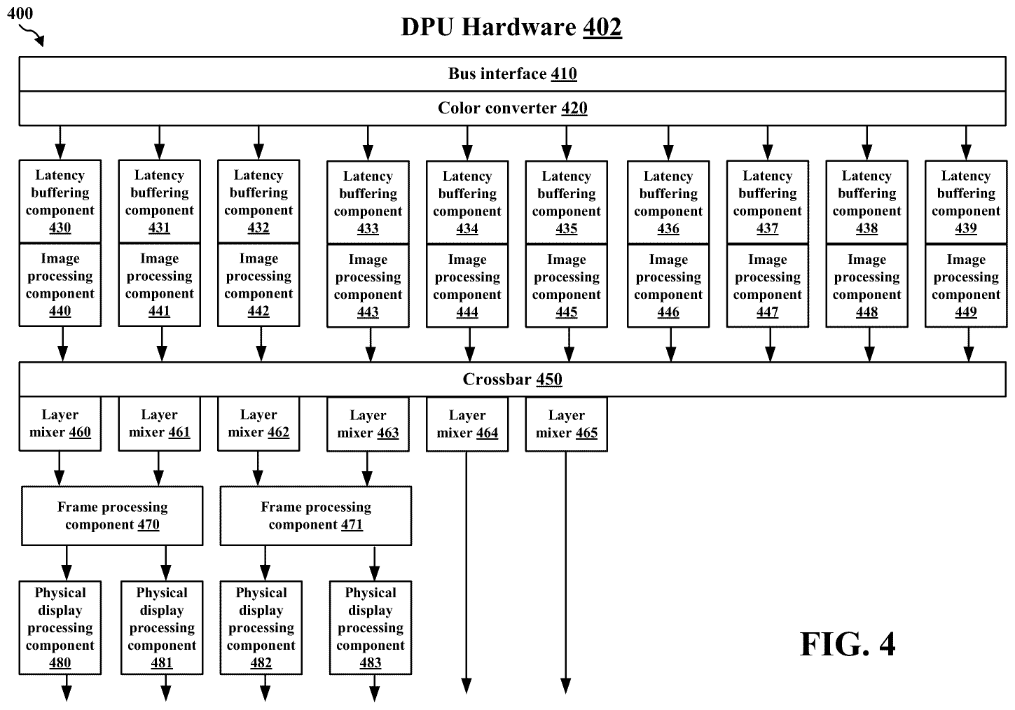

FIG. 4 is a diagram 400 illustrating an example DPU hardware for display processing. More specifically, the diagram 400 depicts DPU hardware 402 that may be used to support different types of display processing, such as image processing or color processing. As shown in FIG. 4, the DPU hardware 402 may include a bus interface 410, a color converter 420, multiple latency buffering components (e.g., a latency buffering component 430, a latency buffering component 431, a latency buffering component 432, a latency buffering component 433, a latency buffering component 434, a latency buffering component 435, a latency buffering component 436, a latency buffering component 437, a latency buffering component 438, and a latency buffering component 439) and multiple image processing components (e.g., an image processing component 440, an image processing component 441, an image processing component 442, an image processing component 443, an image processing component 444, an image processing component 445, an image processing component 446, an image processing component 447, an image processing component 448, and an image processing component 449). DPU hardware 402 may also include a crossbar 450, multiple layer mixers (e.g., a layer mixer 460, a layer mixer 461, a layer mixer 462, a layer mixer 463, a layer mixer 464, and a layer mixer 465), frame processing components (e.g., a frame processing component 470 and a frame processing component 471), and multiple physical display processing components (e.g., a physical display processing component 480, a physical display processing component 481, a physical display processing component 482, and a physical display processing component 483).

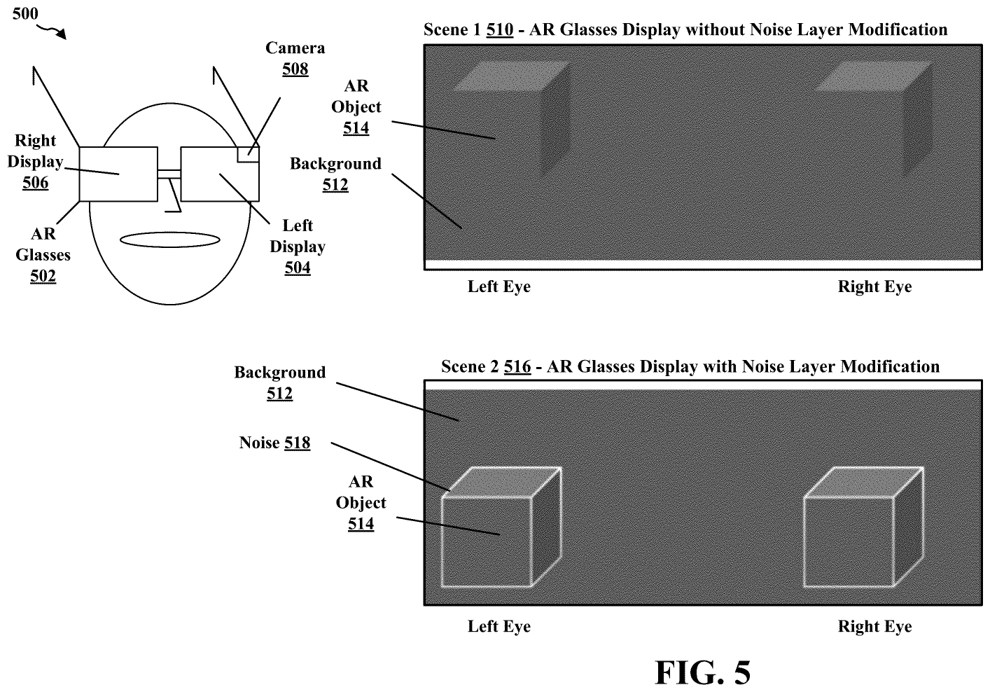

FIG. 5 is a diagram 500 illustrating examples of display frames without and with added noise. A user may wear a display device in order to experienced extended reality (XR) content. XR may refer to a technology that blends aspects of a digital experience and the real world. XR may include augmented reality (AR), mixed reality (MR), and/or virtual reality (VR). In AR, AR objects may be superimposed on a real-world environment as perceived through the display device. In an example, AR content may be experienced through AR glasses that include a transparent or semi-transparent surface. An AR object may be projected onto the transparent or semi-transparent surface of the glasses as a user views an environment through the glasses. In general, the AR object may not be present in the real world and the user may not interact with the AR object. In MR, MR objects may be superimposed on a real-world environment as perceived through the display device and the user may interact with the MR objects. In some aspects, MR objects may include “video see through” with virtual content added. In an example, the user may “touch” a MR object being displayed to the user (i.e., the user may place a hand at a location in the real world where the MR object appears to be located from the perspective of the user), and the MR object may “move” based on the MR object being touched (i.e., a location of the MR object on a display may change). In general, MR content may be experienced through MR glasses (similar to AR glasses) worn by the user or through a head mounted display (HMD) worn by the user. The HMD may include a camera and one or more display panels. The HMD may capture an image of environment as perceived through the camera and display the image of the environment to the user with MR objects overlaid thereon. Unlike the transparent or semi-transparent surface of the AR/MR glasses, the one or more display panels of the HMD may not be transparent or semi-transparent. In VR, a user may experience a fully-immersive digital environment in which the real-world is blocked out. VR content may be experienced through a HMD.

In AR/MR use cases involving AR/MR glasses or a HMD, a projected AR/MR object may not be clearly visible to a user when a color tone of an ambient environment is relatively close to a color tone of the projected AR/VR object. In an example, a user may be wearing AR glasses and a head pose of the user may be directed towards a light source in an environment of the user. In the example, if the light source is white and a projected AR object is also white, the user may not be able to clearly see the AR object as a color tone of the AR object is relatively close to an ambient color of the environment. This may impact user experience, as the user may not be able to accurately differentiate the projected AR/MR object from the real world.

For instance, a user may wear AR glasses 502 over eyes of the user. The AR glasses 502 may include some or all of the hardware and/or software described above in the description of FIGS. 1-4 (e.g., the display processor 127, the processing unit 120, etc.). The AR glasses 502 may include a left display 504 that is positioned on a head of the user such that a left eye of the user perceives an environment through a transparent or semi-transparent surface of the left display 504. The AR glasses 502 may include a right display 506 that is positioned on the head of the user such that a right eye of the user perceives the environment through a transparent or semi-transparent surface of the right display 506.

The AR glasses 502 may include a camera 508. In general, the camera 508 may be oriented such that a lens of the camera 508 is directed away from the face of the user such that the camera 508 is directed towards an environment being perceived by the user. Although the camera 508 is illustrated in the diagram 500 as being on a top right corner of the left display 504, the camera 508 may also be located at other areas on the left display 504 or other areas of the AR glasses 502 (e.g., the right display 506). Furthermore, the AR glasses 502 may include more than one camera.

The diagram 500 includes a first scene 510 that may be experienced by the user via the left display 504 and the right display 506 of the AR glasses 502, where the first scene 510 may correspond to an AR glasses display without noise layer modification. The first scene 510 may include a background 512 of the environment as perceived by the user via the transparent or semi-transparent surfaces of the left display 504 and the right display 506 of the AR glasses 502. The first scene 510 may also include an AR object 514 (e.g., a cube) that is displayed on the left display 504 and the right display 506 by the AR glasses 502. The AR object 514 may be rendered by one or more processors (not depicted in FIG. 5) of the AR glasses 502. The AR object 514 may not be present in the environment in which the user is located. As illustrated in the diagram 500, the AR object 514 may have a similar color tone to a color tone of the background 512, and as such, the user may have difficulty distinguishing the AR object 514 from the background 512. In an example, the AR glasses 502 may be positioned near a light source and the AR object 514 may have a similar color to a color of the light source, thus making it difficult for the user to perceive/experience the AR object 514 when the AR object 514 is presented on the left display 504 and/or the right display 506.

As described above, a user may have difficulty perceiving an AR/MR object when a color tone of the AR object matches (or nearly matches) a color tone of an ambient environment. Various technologies pertaining to enhancing an AR/MR object are described herein. In an example, AR/MR glasses may add noise to edges of an AR/MR object in a display frame when there is a match (or near match) between a color tone of an ambient environment being perceived by the user and a color tone of the AR/MR object. In this manner, the AR/MR object may be detected in a more salient manner that may enhance user experience. In an example, a camera (e.g., a red green blue (RGB) camera) on a HMD or on AR/MR glasses may capture a real world image of an environment being perceived by the user. A first histogram may be generated for the real world image and a second histogram may be generated for a rendered display frame that includes an AR/MR object that is to be displayed to the user. In some aspects, the first histogram may be generated based on local information. For instance, the AR/MR object may be assigned a location within the rendered display frame and the local information may pertain to the area in and/or around the location of the AR/MR object. The first histogram and the second histogram may be compared. When the first histogram and the second histogram are within a threshold range of one another, an amount of noise may be added to the AR/MR object (e.g., to/around edges of the AR/MR object) to make the rendered AR/MR object more salient. The noise added may be calculated based on a match factor that represents a closeness of the first histogram associated with the real-world image to the second histogram associated with the rendered display frame. A layer mixer in DPU hardware may add the noise (i.e., dedicated noise) to frame layers that are incoming from a GPU. The aforementioned aspects will be discussed in greater detail below.

The diagram 500 includes a second scene 516 that may be experienced by the user via the left display 504 and the right display 506 of the AR glasses 502, where the second scene 516 may correspond to an AR glasses display with noise layer modification. Details of the noise layer modification will be discussed in greater detail below. The second scene 516 may include the background 512 of the environment as perceived by the user via the transparent or semi-transparent surfaces of the left display 504 and the right display 506 of the AR glasses 502. The second scene 516 may also include the AR object 514 (e.g., the cube) that is displayed on the left display 504 and/or the right display 506 by the AR glasses 502. However, unlike the first scene 510, the AR object 514 in the second scene 516 may include noise 518. The noise 518 may help the user to distinguish the AR object 514 from the background 512. In an example, the AR glasses 502 may select a color of the noise 518 to be different from a color of the background 512 such that the user may be able to differentiate the AR object 514 from the background 512. In another example, the AR glasses 502 may identify one or more edges of the AR object 514 and add the noise 518 to/around the edges of the AR object 514 such that the user may be able to differentiate the AR object 514 from the background 512. As used herein, “adding noise around the edges of the AR object 514” may refer to adding noise such that the noise and the edges of the AR object 514 make contact without overlapping. As used herein, “adding noise to the edges of the AR object 514” may refer to adding noise such that the noise is overlaid upon the edges of the AR object 514. In yet another example, the AR glasses 502 may determine a strength (i.e., an amount) of noise and add the noise with the determined strength to/around the AR object 514 such that the user may be able to differentiate the AR object 514 from the background 512. Stated differently, the noise 518 may be added to/around edges of the AR object 514 to enhance visualization of the AR object 514.

Although the description of the diagram 500 may focus on AR glasses for AR content, the concepts described above may also be applicable to other types of displays, such as MR glasses or a HMD for AR content and/or VR content. For instance, in the case of a HMD, the background 512 described above may be captured in an image by the camera 508 and projected onto a display panel of the HMD along with the AR object 514 that may have the noise 518 added thereto.

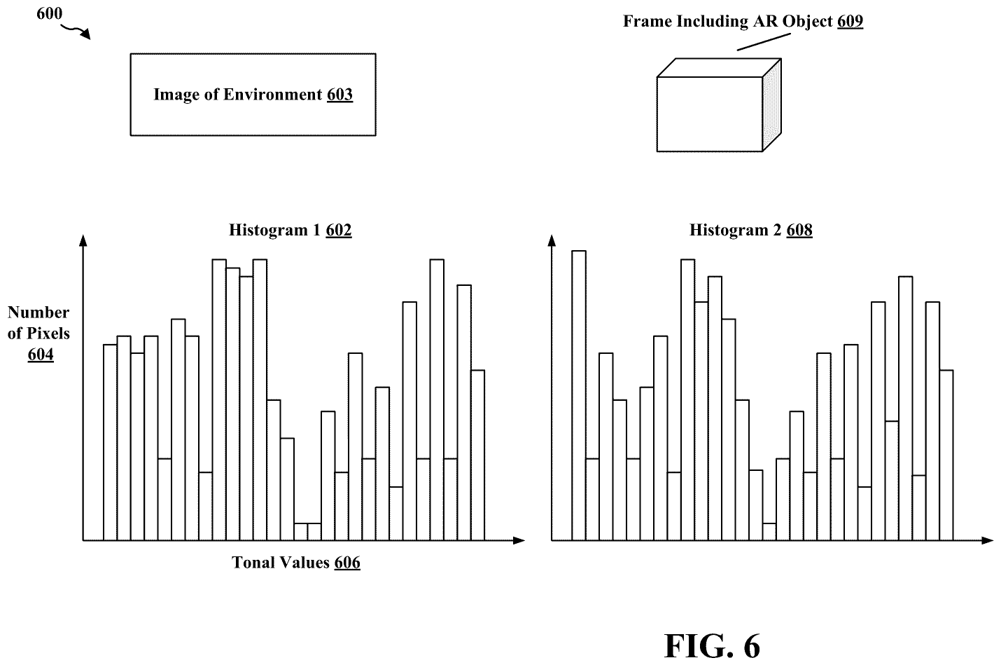

FIG. 6 is a diagram 600 illustrating examples of histograms. A histogram (which may be also be referred to as an “image histogram”) may act as a graphical representation of a tonal distribution in an image or a rendered frame. When displayed, a histogram may plot a number of pixels for each tonal value. The tonal values may correspond to lightness. A histogram may be stored in memory in a data structure that includes entries for possible tonal values and values for each of the entries, where each value in the values corresponds to a number of pixels for a different entry in the entries.

The diagram 600 includes a first histogram 602. The first histogram 602 may be associated with/generated from an image of an environment 603 captured by the camera 508 of the AR glasses 502. In an example, the image of the environment 603 may include the background 512 without the AR object 514. The first histogram 602 may plot a number of pixels 604 (vertical axis) in the image versus tonal values 606 (horizontal axis) in the image of the environment 603. For instance, each rectangular bar in the first histogram 602 may correspond to a different tonal value in the tonal values 606, and a height of each rectangular bar in the first histogram 602 may represent a number of pixels in the image of the environment 603 that have a particular tonal value. In an example, a left side of the horizontal axis may correspond to relatively dark areas associated with the image of the environment 603, a middle portion of the horizontal axis may correspond to mid-tone areas associated with the image of the environment 603, and a right side of the horizontal axis may correspond to relatively light areas associated with the image of the environment 603.

The diagram 600 includes a second histogram 608. The second histogram 608 may be associated with/generated from a frame including an AR object 609 that is to be displayed (e.g., on the left display 504 and/or the right display 506 of the AR glasses 502). In an example, the frame including the AR object 609 may be or include the AR object 514. Similar to the first histogram 602, the second histogram 608 may plot a number of pixels in the frame including the AR object 609 versus tonal values in the frame including the AR object 609. However, as depicted in the diagram 600, the second histogram 608 includes a different tonal distribution than a tonal distribution of the first histogram 602 due to the image of the environment 603 being different than the frame including the AR object 609. For instance, the different tonal distributions between the first histogram 602 and the second histogram 608 may be observed via different heights of corresponding rectangular bars in the first histogram 602 and the second histogram 608. For instance, the left most bars (representing the same tonal value) of the first histogram 602 and the second histogram 608 may have different heights to indicate that the image of the environment 603 has relatively fewer pixels of a particular tonal value in comparison to pixels of the particular tonal values in the frame including the AR object 609.

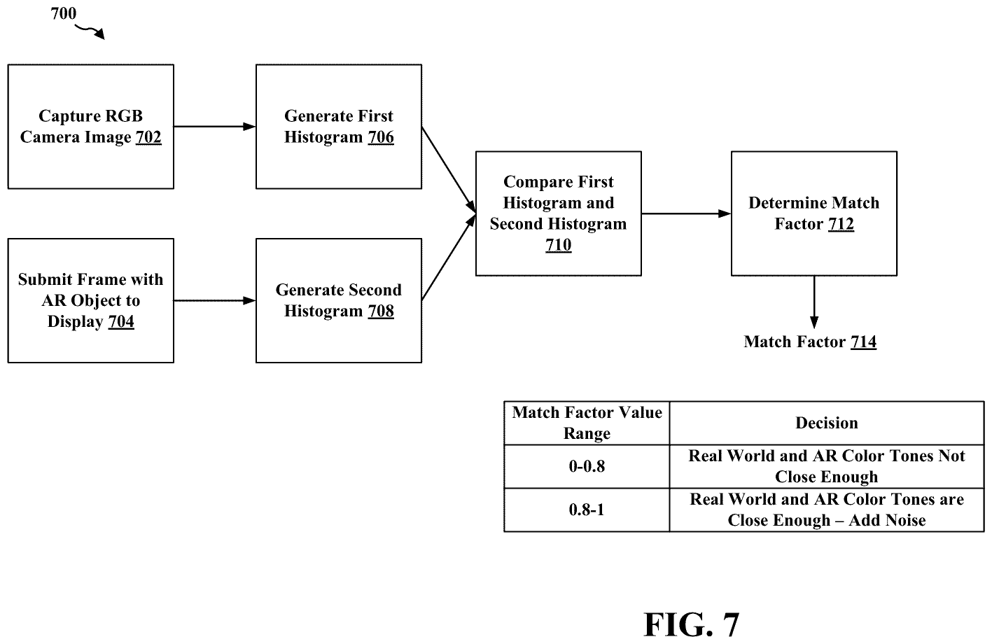

FIG. 7 is a diagram 700 illustrating an example process for determining a match factor. In an example, the AR glasses 502 (or MR glasses or a HMD) may utilize the process to determine the match factor. At 702, the AR glasses 502 may capture a RGB camera image via the camera 508. The RGB camera image may be an image of an environment that is being perceived by the user. In an example, the RGB camera image may be the image of the environment 603. At 704, the AR glasses 502 may submit a frame that includes an AR object that is to be displayed. In an example, the frame may be the frame including the AR object 609. In another example, the AR object may be the AR object 514.

At 706, the AR glasses 502 may generate a first histogram based on the RGB camera image captured at 702. In an example, the first histogram may be the first histogram 602. At 708, the AR glasses 502 may generate a second histogram based on the frame that includes the AR object. In an example, the second histogram may be the second histogram 608. At 710, the AR glasses 502 may compare the first histogram and the second histogram. At 712, the AR glasses 502 may determine a match factor 714 based on the comparison performed at 710. The match factor 714 may be indicative of a closeness of the first histogram to the second histogram. More specifically, the match factor 714 may be indicative of a closeness of a tonal distribution of the RGB camera image to a tonal distribution of the frame that includes the AR object. The AR glasses 502 may determine whether noise is to be added to the frame that includes the AR object based on the match factor 714 and at least one threshold value.

In an example, comparing the first histogram and the second histogram may include comparing a first number of pixels for a tonal value in the first histogram to a second number of pixels for the tonal value in the second histogram. The AR glasses 502 may assign a score to the tonal value based on the comparison. In general, a relatively higher score may indicate that the first number of pixels and the second number of pixels for the tonal value are equal (or relatively near one another) and a relatively lower score may indicate that the first number of pixels and the second number of pixels for the tonal value are relatively different from one another. In one aspect, the tonal values may be assigned weights that are multiplied by the score in order to give certain tonal values more or less importance in determining the match factor 714. The AR glasses 502 may repeat this process for each tonal value represented in the first histogram and the second histogram to obtain scores for each tonal value. The AR glasses 502 may then sum the scores to obtain the match factor 714.

In one aspect, the match factor 714 may range from 0 to 1 and the at least one threshold value may be associated with a particular range. In an example, if the match factor 714 falls within 0 to 0.8, the AR glasses 502 may determine that the RGB camera image captured at 702 and the frame with the AR object submitted at 704 have color tones that are relatively far apart and hence may likely be readily distinguished from one another by a user. In another example, if the match factor 714 falls within 0.8 to 1, the AR glasses 502 may determine that the RGB camera image captured at 702 and the frame with the AR object submitted at 704 have color tones that are relatively near each other. Based on the determination that the match factor 714 falls within the 0.8 to 1 range, the AR glasses 502 may add noise to/around the AR object to help the user to visually distinguish the AR object from an environment being perceived by the user. In one aspect, if the match factor 714 is 0.8, the AR glasses may add the noise to/around the AR object. In another aspect, if the match factor 714 is 0.8, the AR glasses may not add the noise to/around the AR object.

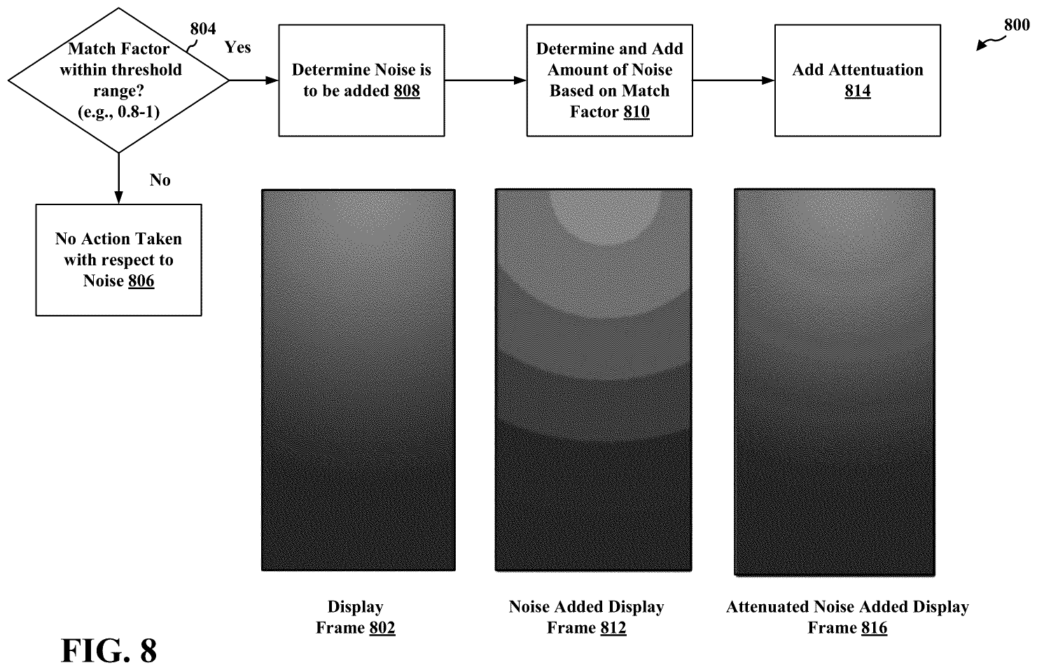

FIG. 8 is a diagram 800 illustrating an example process for determining whether noise is to be added to a display frame 802, determining an amount of the noise to be added to the display frame 802, and adding attenuation to the display frame 802. In an example, the AR glasses 502 (or MR glasses or a HMD) may utilize the process to determine whether noise is to be added to a display frame and to determine an amount (i.e., strength) of the noise. In an example, the display frame 802 may be or include the frame including the AR object 609 or the AR object 514.

At 804, the AR glasses 502 may determine whether a match factor (e.g., the match factor 714) falls within a threshold range (e.g., 0.8 to 1). In an example, the AR glasses 502 may determine the match factor based upon a first histogram of a real world image (e.g., the image of the environment 603) and a second histogram for the display frame 802. Upon negative determination, at 806, the AR glasses 502 may display the display frame 802 on the left display 504 and/or the right display 506 without adding noise.

Upon positive determination, at 808, the AR glasses 502 may determine that noise is to be added to the display frame 802. At 810, the AR glasses 502 may determine an amount (i.e., a strength) of the noise based on the match factor and the AR glasses 502 may add the amount of noise to the display frame 802 to obtain a noise added display frame 812. As illustrated in the diagram 800, the noise added display frame 812 may have more salient edges compared to the display frame 802 such than an AR object may be perceived more clearly by a user. Details of determining the amount/strength of the noise will be described in greater detail below. At 814, the AR glasses 502 may add attenuation to the noise added display frame 812 to generate an attenuated noise added display frame 816. The attenuation may smooth contours in the noise added display frame 812. As illustrated in the diagram 800, the attenuated noise added display frame 816 may have more salient edges compared to the noise added display frame 812 such that the AR object may be perceived more clearly by the user.

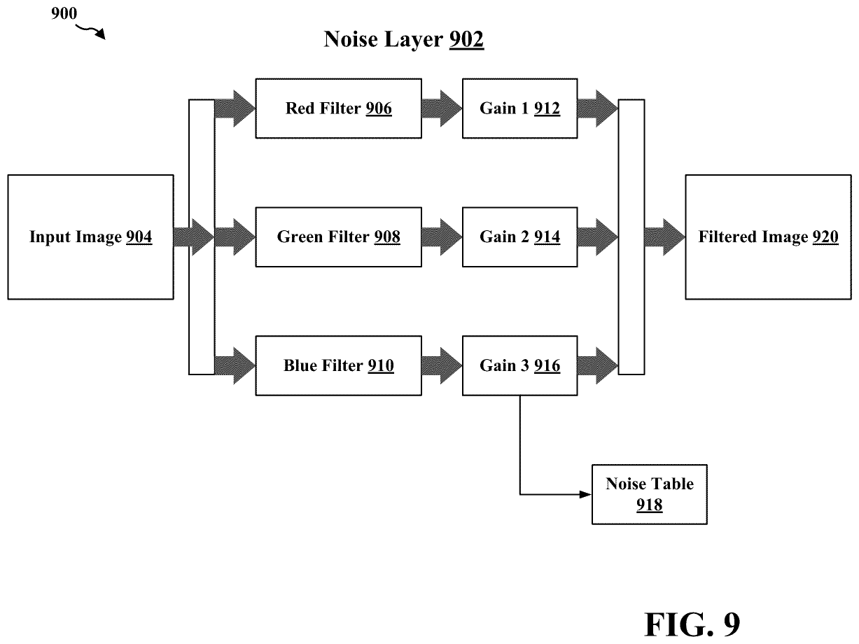

FIG. 9 is a diagram 900 illustrating example aspects of a noise layer 902 for adding noise to a display frame. The noise layer 902 may be included in hardware of the AR glasses 502. In an example, the noise layer 902 may be associated with one or more of the layer mixers 460-465. The noise layer 902 may add noise (e.g., dither noise) when a match factor (e.g., the match factor 714) falls within a threshold range (e.g., 0.8 to 1). The noise layer 902 may generate a 10-bit luma (R=G=B) noise surface. In an example, the noise and/or the noise surface may be or include the noise 518 or the noise and/or the noise surface may be associated with the noise 518. In an example, the noise layer 902 may generate the noise/noise surface based on a noise table 918. The noise layer 902 may determine/calculate an amount (i.e., a strength) of noise based on the noise table 918. In one aspect, the noise table 918 may be an ordered dither matrix. In one aspect, the noise table 918 may be a 4×4 spatial noise table. In one aspect, the noise table 918 may be the “NoiseTable” in equation (I) provided below.

$$NoiseTable = [ \begin{matrix}15 & 7 & 13 & 5 \\ 3 & 11 & 1 & 9 \\ 12 & 4 & 14 & 6 \\ 0 & 8 & 2 & 10\end{matrix} ] \qquad ( I )$$

In an example, a noise source associated with the noise table 918 may be attached as a foreground source to a layer in a layer mixer (e.g., one or more of the layer mixers 460-465). In one aspect, a layer mixer (e.g., a layer mixer in the layer mixers 460-465) may attach noise to a single layer. The noise source may generate a surface (i.e., a noise surface) that covers an entirety of a layer mixer canvas.

In an example, the noise layer 902 may obtain an input image 904. In an example, the input image 904 may include an AR object that is to be displayed. In an example, the input image 904 may be or include the AR object 514, the frame including the AR object 609, and/or the display frame 802. The noise layer 902 may process the input image 904 with respect to a red filter 906, a green filter 908, and a blue filter 910. Each of the red filter 906, the green filter 908, and the blue filter 910 may be associated with a first gain 912, a second gain 914, and a third gain 916. In an example, the first gain 912 may be a first noise gain, the second gain 914 may be a second noise gain, and the third gain 916 may be a third noise gain. The noise layer 902 may determine one or more of the first noise gain, the second noise gain, and the third noise gain based on the noise table 918. The noise layer 902 may then output a filtered image 920, where the filtered image 920 includes noise. In an example, the noise may be the noise 518. In another example, the filtered image 920 may be the noise added display frame 812 or the attenuated noise added display frame 816.

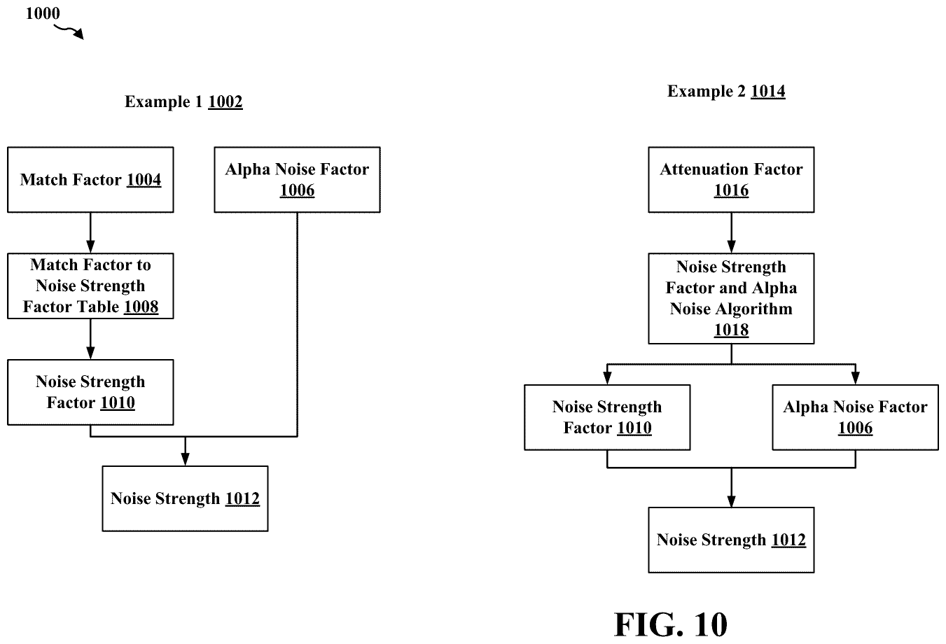

FIG. 10 is a diagram 1000 illustrating example aspects of computing noise strength for noise that is to be added to a frame that includes a AR object. A noise strength may be based on a noise strength factor and a noise alpha factor. In an example, the noise may be the noise 518 and the AR object may be the AR object 514. In another example, the frame that includes the AR object may be the frame including the AR object 609 or the display frame 802.

In a first example 1002, the AR glasses 502 may obtain/determine/calculate a match factor 1004 as described above in the description of FIGS. 7 and 8. The AR glasses 502 may also obtain an alpha noise factor 1006. The alpha noise factor 1006 may be alternatively referred to as “αNOISE,” “noise alpha,” or a “noise alpha factor.” The alpha noise factor 1006 may be applied to a noise source when noise is blended with source content in a layer mixer (e.g., for smoother contours).

The AR glasses 502 may access a match factor noise strength factor table 1008 to determine a noise strength factor 1010. The AR glasses may derive the match factor noise strength factor table 1008 or the match factor noise strength factor table 1008 may be predefined. The match factor noise strength factor table 1008 may map match factors to noise strength factors. In an example, the match factor noise strength factor table 1008 may map the match factor 714 to a corresponding noise strength factor (e.g., the noise strength factor 1010). The AR glasses 502 may determine a noise strength 1012 based on the noise strength factor 1010 and the alpha noise factor 1006. The AR glasses 502 may add noise to the frame, where the noise has the noise strength 1012. In an example, the noise may be the noise 518. In an example, the AR glasses 502 may add noise to/around an edge (or edges) of an AR object in the frame. The match factor noise strength factor table 1008 may be a lookup table (LUT).

In a second example 1014, the AR glasses 502 may obtain an attenuation factor 1016 (also referred to herein as “αATTN”). The attenuation factor 1016 may be specified by a manufacturer of the AR glasses 502. The AR glasses 502 may input the attenuation factor 1016 to a noise strength factor and alpha noise algorithm 1018 and obtain the noise strength factor 1010 and the alpha noise factor 1006 as an output of the noise strength factor and alpha noise algorithm 1018. In an example, the noise strength factor and alpha noise algorithm 1018 may include equations (II) and (III) below for determining the noise strength factor 1010 and the alpha noise factor 1006, respectively.

$$NoiseStrengthFactor = max ( ceil ( {log}_{2} \frac{1}{2 * α ATTN * NoiseMean} ) , 0 ) \qquad ( II )$$

$$α NOISE = \frac{255}{2 * α ATTN * NoiseMean * 2 - NoiseStrengthFactor} \qquad ( III )$$

In equations (II) and (III) above, “NoiseMean” may be predefined or computed based on a metric.

The AR glasses 502 may determine the noise strength 1012 based on the noise strength factor 1010 and the alpha noise factor 1006. The AR glasses 502 may add noise to the frame, where the noise has the noise strength 1012. In an example, the noise may be the noise 518. In an example, the AR glasses 502 may add noise to/around an edge (or edges) of an AR object in the frame.

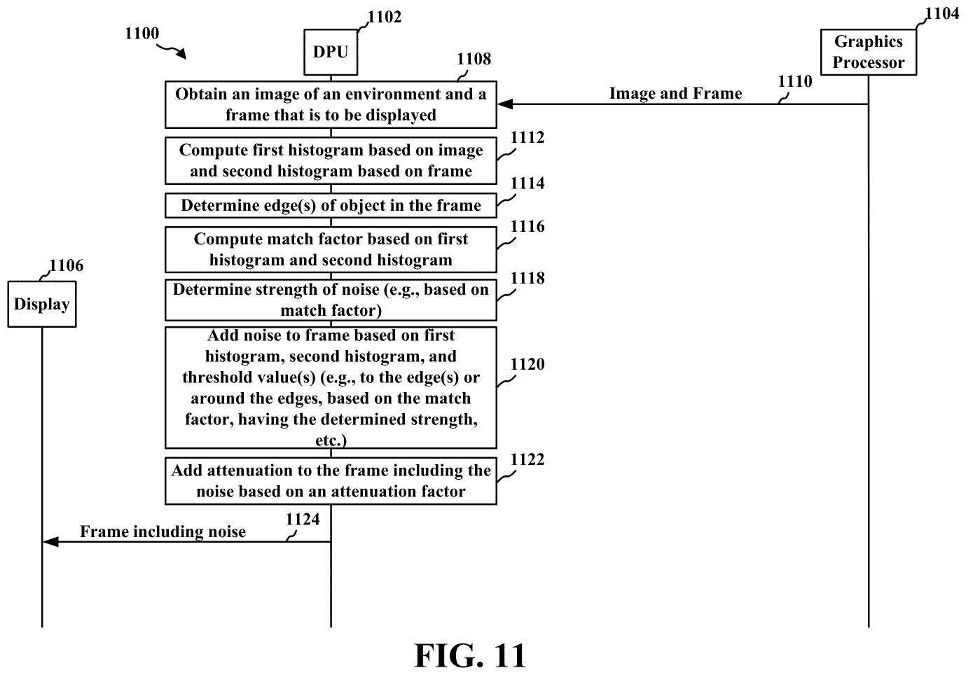

FIG. 11 is a call flow diagram 1100 illustrating example communications between a DPU 1102, a graphics processor 1104 (e.g., a GPU), and a display 1106 in accordance with one or more techniques of this disclosure. In an example, the DPU 1102, the graphics processor 1104, and the display 1106 may be included in an XR device, such as the AR glasses 502.

At 1108, the DPU 1102 may obtain an image of an environment and a frame that is to be displayed. For example, at 1110, the DPU 1102 may receive the image of the environment and the frame that is to be displayed from the graphics processor 1104. The frame may include an object (e.g., an AR object or a MR object). At 1112, the DPU 1102 may compute a first histogram based on the image of the environment and a second histogram based on the frame. At 1114, the DPU 1102 may determine edge(s) of the object in the frame. At 1116, the DPU 1102 may compute a match factor based on the first histogram and the second histogram. At 1118, the DPU 1102 may determine a strength of noise that is to be added to the frame.

At 1120, the DPU 1102 may add noise to the frame based on the first histogram, the second histogram, and threshold value(s). In an example, the DPU 1102 may add the noise to the edge(s) of the object or around the edge(s) of the object. In an example, the DPU 1102 may add the noise to the frame based on the match factor computed at 1116. In an example, the DPU 1102 may add the noise to the frame such that the noise has the strength determined at 1118. At 1122, the DPU 1102 may add attenuation to the frame including the noise based on an attenuation factor. At 1124, the DPU 1102 may transmit the frame including the noise to the display 1106 for presentation on the display 1106.

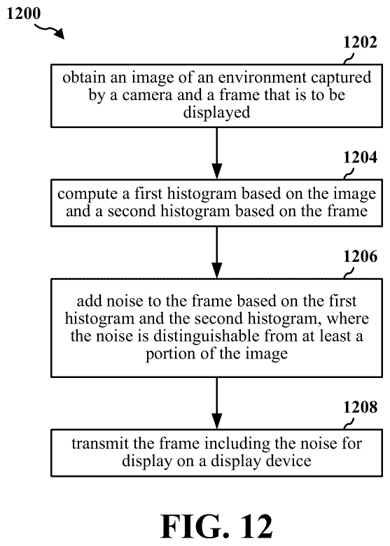

FIG. 12 is a flowchart 1200 of an example method of display processing in accordance with one or more techniques of this disclosure. The method may be performed by an apparatus, such as an apparatus for display processing, a display processing unit (DPU) or other display processor, a wireless communication device, and the like, as used in connection with the aspects of FIGS. 1-11. In an example, the apparatus (e.g., display processor) may be or include the device 104, the display processor 127, the DPU hardware 402, the AR glasses 502, and/or the DPU 1102. The method may be associated with various advantages at the apparatus, such as increasing the visibility of a displayed XR (e.g., AR, MR, etc.) object. In an example, the method may be performed by the noise applier 198.

At 1202, the apparatus (e.g., display processor) obtains an image of an environment captured by a camera and a frame that is to be displayed. For example, FIG. 11 at 1108 shows that the DPU 1102 may obtain an image of an environment and a frame that is to be displayed. In an example, the image of the environment may be the image of the environment 603 and the frame may be the frame including the AR object 609. In another example, the camera may be the camera 508, the image of the environment may correspond to the first scene 510 (not including the AR object 514), and the frame that is to be displayed may include the AR object 514. In a further example, the image of the environment may be the RGB camera image captured at 702 and the frame may be the frame with the AR object submitted at 704. In yet another example, the frame that is to be displayed may be or include the display frame 802. In an example, 1202 may be performed by the noise applier 198.

At 1204, the apparatus (e.g., display processor) computes a first histogram based on the image and a second histogram based on the frame. For example, FIG. 11 at 1112 shows that the DPU 1102 may compute a first histogram based on the image and a second histogram based on the frame. In an example, the first histogram may be the first histogram 602 and the second histogram may be the second histogram 608. In an example, 1204 may be performed by the noise applier 198.

At 1206, the apparatus (e.g., display processor) adds noise to the frame based on the first histogram and the second histogram, where the noise is distinguishable from at least a portion of the image. For example, FIG. 11 at 1120 shows that the DPU 1102 may add noise to the frame based on the first histogram, the second histogram, and threshold value(s). In an example, the noise may be or include the noise 518. Furthermore, the second scene 516 shows that the noise 518 may be distinguishable from the background 512 (e.g., the noise 518 may have a white color tone and the background 512 may have a dark color tone). In yet another example, adding noise to the frame may include aspects described above in relation to FIG. 9. In a further example, adding the noise to the frame may generate the noise added display frame 812. In an example, 1206 may be performed by the noise applier 198.

At 1208, the apparatus (e.g., display processor) transmits the frame including the noise for display on a display device. For example, FIG. 11 at 1124 shows that the DPU 1102 may transmit a frame including noise for display on the display 1106. In another example, the display device may be or include the display(s) 131, the left display 504, and/or the right display 506. In yet another example, the frame including the noise may be displayed as depicted in the second scene 516. In an example, 1208 may be performed by the noise applier 198.

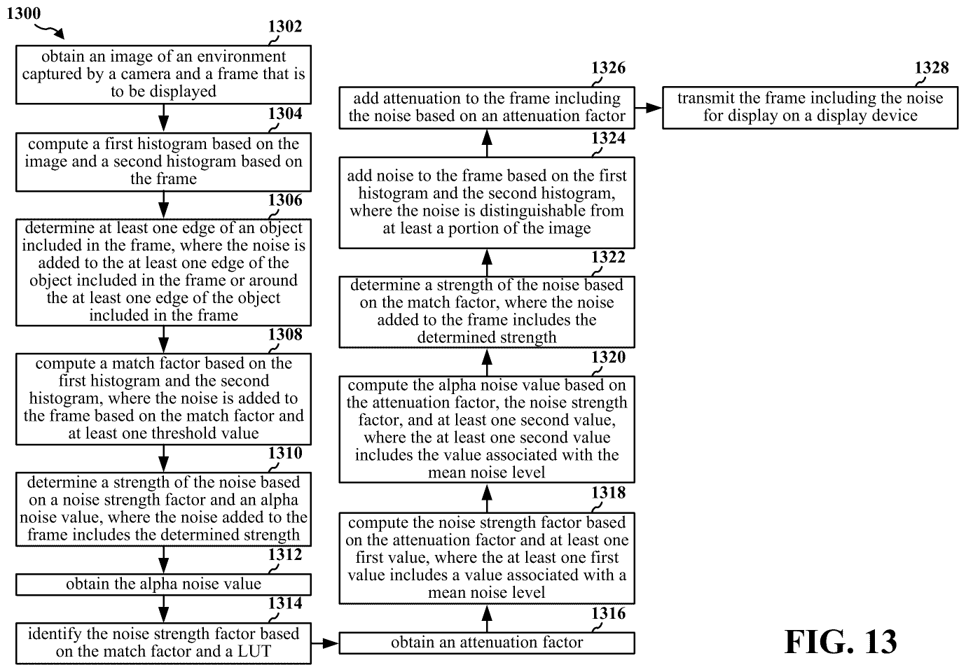

FIG. 13 is a flowchart 1300 of an example method of display processing in accordance with one or more techniques of this disclosure. The method may be performed by an apparatus, such as an apparatus for display processing, a display processing unit (DPU) or other display processor, a wireless communication device, and the like, as used in connection with the aspects of FIGS. 1-11. In an example, the apparatus (e.g., display processor) may be or include the device 104, the display processor 127, the DPU hardware 402, the AR glasses 502, and/or the DPU 1102. The method may be associated with various advantages at the apparatus, such as increasing the visibility of a displayed XR (e.g., AR, MR, etc.) object. In an example, the method (including the various aspects detailed below) may be performed by the noise applier 198.

At 1302, the apparatus (e.g., display processor) obtains an image of an environment captured by a camera and a frame that is to be displayed. For example, FIG. 11 at 1108 shows that the DPU 1102 may obtain an image of an environment and a frame that is to be displayed. In an example, the image of the environment may be the image of the environment 603 and the frame may be the frame including the AR object 609. In another example, the camera may be the camera 508, the image of the environment may correspond to the first scene 510 (not including the AR object 514), and the frame that is to be displayed may include the AR object 514. In a further example, the image of the environment may be the RGB camera image captured at 702 and the frame may be the frame with the AR object submitted. In yet another example, the frame that is to be displayed may be or include the display frame 802. In an example, 1302 may be performed by the noise applier 198.

At 1304, the apparatus (e.g., display processor) computes a first histogram based on the image and a second histogram based on the frame. For example, FIG. 11 at 1112 shows that the DPU 1102 may compute a first histogram based on the image and a second histogram based on the frame. In an example, the first histogram may be the first histogram 602 and the second histogram may be the second histogram 608. In an example, 1304 may be performed by the noise applier 198.

At 1324, the apparatus (e.g., display processor) adds noise to the frame based on the first histogram and the second histogram, where the noise is distinguishable from at least a portion of the image. For example, FIG. 11 at 1120 shows that the DPU 1102 may add noise to the frame based on the first histogram, the second histogram, and threshold value(s). In an example, the noise may be or include the noise 518. Furthermore, the second scene 516 shows that the noise 518 may be distinguishable from the background 512 (e.g., the noise 518 may have a white color tone and the background 512 may have a dark color tone). In yet another example, adding noise to the frame may include aspects described above in relation to FIG. 9. In a further example, adding the noise to the frame may generate the noise added display frame 812. In an example, 1324 may be performed by the noise applier 198.

At 1328, the apparatus (e.g., display processor) transmits the frame including the noise for display on a display device. For example, FIG. 11 at 1124 shows that the DPU 1102 may transmit a frame including noise for display on the display 1106. In another example, the display device may be or include the display(s) 131, the left display 504, and/or the right display 506. In yet another example, the frame including the noise may be displayed as depicted in the second scene 516. In an example, 1328 may be performed by the noise applier 198.

In one aspect, at 1306, the frame may include an object that is to be displayed on the display device, and the apparatus may determine at least one edge of the object, where the noise may be added to the at least one edge of the object included in the frame or around the at least one edge of the object included in the frame. For example, FIG. 11 at 1114 shows that the DPU 1102 may determine edge(s) of an object in a frame. Furthermore, FIG. 11 at 1120 shows that the DPU 1102 may add the noise to or around the edge(s) of the object in the frame. In another example, the object may be or include the AR object 514, the apparatus may determine at least one edge of the AR object 514, and the apparatus may add noise to or around the at least one edge of the AR object 514 as depicted in the second scene 516. In an example, 1306 may be performed by the noise applier 198.

In one aspect, at 1308, the apparatus (e.g., display processor) may compute a match factor based on the first histogram and the second histogram, where the noise may be added to the frame based on the match factor and at least one threshold value. For example, FIG. 11 at 1116 shows that the DPU 1102 may compute a match factor based on the first histogram and the second histogram. Furthermore, FIG. 11 at 1120 shows that the noise added to the frame may be based on the match factor computed at 1116. In another example, the match factor may be the match factor 714 and computing the match factor may include aspects described above in relation to FIG. 7 (e.g., determining the match factor 714 at 712). In an example, the at least one threshold value may be or include values (e.g., 0.0, 0.8. 1) associated with the match factor value ranges illustrated in FIG. 7. In an example, 1308 may be performed by the noise applier 198.

In one aspect, the first histogram may include a first distribution of pixel values associated with the environment, and the second histogram may include a second distribution of pixel values associated with the frame. For example, the first distribution of pixel values may be the distribution of pixel values corresponding to the first histogram 602 and the second distribution of pixel values may be the distribution of pixel values corresponding to the second histogram 608.

In one aspect, the match factor may be indicative of a closeness of the first distribution of the pixel values to the second distribution of the pixel values. For example, the match factor computed at 1116 may be indicative of a closeness of the first distribution of the pixel values to the second distribution of the pixel values.

In one aspect, the at least one threshold value may include a first threshold value and a second threshold value, where the first threshold value and the second threshold value may define a range, and where the noise may be added to the frame based on the match factor being within the range. For example, as depicted in FIG. 7, the first threshold value may be “0.8,” the second threshold value may be “1,” and the range may be “0.8-1.” In another example, FIGS. 8 at 804 and 808 shows that noise may be added to the display frame 802 (to generate the noise added display frame 812) if the match factor is within a threshold range.

In one aspect, at 1310, the apparatus (e.g., display processor) may determine a strength of the noise based on a noise strength factor and an alpha noise value, where the noise added to the frame may include the determined strength. For example, FIG. 11 at 1118 shows that the DPU 1102 may determine a strength of noise that is to be added to the frame. Furthermore, FIG. 11 at 1120 shows that the noise added to the frame may have the strength determined at 1118. In an example, the noise strength factor may be the noise strength factor 1010, the alpha noise value may be the alpha noise factor 1006, and the strength of the noise may be the noise strength 1012. In another example, FIG. 8 at 810 shows that an amount of noise (i.e., a strength of noise) may be determined. In an example, 1310 may be performed by the noise applier 198.

In one aspect, at 1312, the apparatus (e.g., display processor) may obtain the alpha noise value. For instance, the first example 1002 in FIG. 10 shows that an alpha noise factor 1006 may be obtained. In an example, 1312 may be performed by the noise applier 198.

In one aspect, at 1314, the apparatus (e.g., display processor) may identify the noise strength factor based on the match factor and a LUT, where the LUT may include a plurality of match factors and a plurality of noise strength factors for the plurality of match factors. For instance, the first example 1002 in FIG. 10 shows that the noise strength factor 1010 may be obtained via a match factor noise strength factor table 1008. The LUT may be or include the match factor noise strength factor table 1008. The match factor noise strength factor table 1008 may include a plurality of match factors and a plurality of noise strength factors for the plurality of match factors. In another example, identifying the noise strength factor based on the match factor and the LUT may include aspects described above in connection with FIG. 9. In an example, 1314 may be performed by the noise applier 198.

In one aspect, at 1316, the apparatus (e.g., display processor) may obtain an attenuation factor. For instance, the second example 1014 in FIG. 10 shows that an attenuation factor 1016 may be obtained. In an example, 1316 may be performed by the noise applier 198.

In one aspect, at 1318, the apparatus (e.g., display processor) may compute the noise strength factor based on the attenuation factor and at least one first value, where the at least one first value may include a value associated with a mean noise level. For instance, the second example 1014 in FIG. 10 shows that the noise strength factor 1010 may be computed based on the attenuation factor 1016 and a noise strength factor and alpha noise algorithm 1018. In an example, the noise strength factor may be computed according to equation (II) above. In an example, 1318 may be performed by the noise applier 198.

In one aspect, at 1320, the apparatus (e.g., display processor) may compute the alpha noise value based on the attenuation factor, the noise strength factor, and at least one second value, where the at least one second value may include the value associated with the mean noise level. For instance, the second example 1014 in FIG. 10 shows that the alpha noise factor 1006 may be computed based on the attenuation factor 1016, the noise strength factor 1010, and the noise strength factor and alpha noise algorithm 1018. In an example, the alpha noise value may be computed according to equation (III) above. In an example, 1320 may be performed by the noise applier 198.

In one aspect, at 1322, the apparatus (e.g., display processor) may determine a strength of the noise based on the match factor, where the noise added to the frame may include the determined strength. For example, FIG. 11 at 1118 shows that the DPU 1102 may determine a strength of noise based on the match factor computed at 1116. Furthermore, FIG. 11 at 1120 shows that the noise may be added to the frame such that the noise has the strength determined at 1118. In another example, FIG. 8 at 810 shows that an amount of noise (i.e., a strength of noise) may be added based on a match factor. In an example, 1322 may be performed by the noise applier 198.

In one aspect, at 1326, the apparatus (e.g., display processor) may add attenuation to the frame including the noise based on an attenuation factor. For example, FIG. 11 at 1122 shows that the DPU 1102 may add attenuation to the frame including the noise based on an attenuation factor. In an example, the attenuation factor may be the attenuation factor 1016. In another example, FIG. 8 at 814 shows that attenuation may be added to the noise added display frame 812 to obtain the attenuated noise added display frame 816. In an example, 1326 may be performed by the noise applier 198.

In one aspect, the noise includes dither noise. For example, the noise 518 may include dither noise. In another example, the noise added display frame 812 may include dither noise.

In one aspect, the dither noise may be added to the frame further based on at least one dither matrix. For example, the noise 518 may be added to a frame based on at least one dither matrix. In another example, noise in the noise added display frame 812 may be added based on at least one dither matrix.

In one aspect, obtaining the frame that is to be displayed may include receiving the frame from a graphics processor. For example, FIG. 11 at 1110 shows that the DPU 1102 may receive the frame from the graphics processor 1104. In another example, the GPU may be or include aspects described above in connection with FIGS. 1 and 2.

In one aspect, the noise may be added to the frame at a layer mixer of a DPU. For example, the layer mixer of the DPU may be included in the DPU hardware 402. In another example, the layer mixer may be or include the laxer mixers 460-465. In a further example, the layer mixer of the DPU may include the noise layer 902 and the noise may be added to the frame at the noise layer 902.

In one aspect, at least one of a first brightness or a first chrominance of the noise may differ from at least one of a second brightness or a second chrominance of at least the portion of the image. For example, a brightness and/or a chrominance of the noise 518 may differ from a brightness and/or a chrominance of the background 512 in the second scene 516.

In one aspect, the camera and the display device may be included in a VR device, an AR device, or a MR device. For example, the camera and the display device may be included in the AR glasses 502.

In one aspect, a lens of the camera and a surface of the display device may be oriented towards a point in the environment when the image is captured. For example, a lens of the camera 508 and a surface of the left display 504 and/or the right display 506 may be oriented toward a point in the environment when an image is captured by the camera 508.

In one aspect, the display device may include at least one display panel. For example, the at least one display panel may be or include the left display 504 and/or the right display 506. In another example, the at least one display panel may be or include the display(s) 131.

In one aspect, the frame including the noise may be overlaid on the image of the environment when displayed on the at least one display panel. For example, the second scene 516 shows that a frame including the AR object 514 with the noise 518 added thereto may be overlaid upon a background 512 when displayed on the left display 504 and/or the right display 506.

In one aspect, the display device may include at least one transparent surface or at least one semi-transparent surface. For example, the left display 504 and/or the right display 506 may be or include a transparent surface or a semi-transparent surface and the frame may be displayed on the transparent surface or the-semi-transparent surface.

In one aspect, the frame may be displayed on the at least one transparent surface or the at least one semi-transparent surface. For example, the left display 504 and/or the right display 506 may be or include a transparent surface or a semi-transparent surface and the frame may be displayed on the transparent surface or the-semi-transparent surface.

In configurations, a method or an apparatus for display processing is provided. The apparatus may be a DPU, a display processor, or some other processor that may perform display processing. In aspects, the apparatus may be the display processor 127 within the device 104, or may be some other hardware within the device 104 or another device. The apparatus may include means for obtaining an image of an environment captured by a camera and a frame that is to be displayed. The apparatus may further include means for computing a first histogram based on the image and a second histogram based on the frame. The apparatus may include means for adding noise to the frame based on the first histogram and the second histogram, where the noise is distinguishable from at least a portion of the image. The apparatus may include means for transmitting the frame including the noise for display on a display device. The apparatus may include means for determining at least one edge of the object, where the noise is added to the at least one edge of the object included in the frame or around the at least one edge of the object included in the frame. The apparatus may include means for computing a match factor based on the first histogram and the second histogram, where the noise is added to the frame based on the match factor and at least one threshold value. The apparatus may include means for determining a strength of the noise based on a noise strength factor and an alpha noise value, where the noise added to the frame includes the determined strength. The apparatus may include means for obtaining the alpha noise value. The apparatus may include means for identifying the noise strength factor based on the match factor and a LUT, where the LUT includes a plurality of match factors and a plurality of noise strength factors for the plurality of match factors. The apparatus may include means for obtaining an attenuation factor. The apparatus may include means for computing the noise strength factor based on the attenuation factor and at least one first value, where the at least one first value includes a value associated with a mean noise level. The apparatus may include means for computing the alpha noise value based on the attenuation factor, the noise strength factor, and at least one second value, where the at least one second value includes the value associated with the mean noise level. The apparatus may include means for determining a strength of the noise based on the match factor, where the noise added to the frame includes the determined strength. The apparatus may include means for adding attenuation to the frame including the noise based on an attenuation factor.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may comprise RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of display processing, including: obtaining an image of an environment captured by a camera and a frame that is to be displayed; computing a first histogram based on the image and a second histogram based on the frame; adding noise to the frame based on the first histogram and the second histogram, where the noise is distinguishable from at least a portion of the image; and transmitting the frame including the noise for display on a display device.

Aspect 2 may be combined with aspect 1 and includes that the frame includes an object that is to be displayed on the display device, and further includes determining at least one edge of the object, where the noise is added to the at least one edge of the object included in the frame or around the at least one edge of the object included in the frame.

Aspect 3 may be combined with any of aspects 1-2 and further includes computing a match factor based on the first histogram and the second histogram, where the noise is added to the frame based on the match factor and at least one threshold value.

Aspect 4 may be combined with aspect 3 and includes that the first histogram includes a first distribution of pixel values associated with the environment, and where the second histogram includes a second distribution of pixel values associated with the frame.

Aspect 5 may be combined with aspect 4 and includes that the match factor is indicative of a closeness of the first distribution of the pixel values to the second distribution of the pixel values.

Aspect 6 may be combined with any of aspects 3-5 and includes that the at least one threshold value includes a first threshold value and a second threshold value, where the first threshold value and the second threshold value define a range, and where the noise is added to the frame based on the match factor being within the range.

Aspect 7 may be combined with any of aspects 3-6 and further includes determining a strength of the noise based on a noise strength factor and an alpha noise value, where the noise added to the frame includes the determined strength.

Aspect 8 may be combined with aspect 7 and further includes obtaining the alpha noise value; and identifying the noise strength factor based on the match factor and a LUT, where the LUT includes a plurality of match factors and a plurality of noise strength factors for the plurality of match factors.

Aspect 9 may be combined with aspect 7 and further includes obtaining an attenuation factor; computing the noise strength factor based on the attenuation factor and at least one first value, where the at least one first value includes a value associated with a mean noise level; and computing the alpha noise value based on the attenuation factor, the noise strength factor, and at least one second value, where the at least one second value includes the value associated with the mean noise level.

Aspect 10 may be combined with any of aspects 3-6 and further includes determining a strength of the noise based on the match factor, where the noise added to the frame includes the determined strength.

Aspect 11 may be combined with any of aspects 1-10 and further includes adding attenuation to the frame including the noise based on an attenuation factor.

Aspect 12 may be combined with any of aspects 1-11 and includes that the noise includes dither noise.

Aspect 13 may be combined with aspect 12 and includes that the dither noise is added to the frame further based on at least one dither matrix.

Aspect 14 may be combined with any of aspects 1-13 and includes that obtaining the frame that is to be displayed includes receiving the frame from a graphics processor.

Aspect 15 may be combined with any of aspects 1-14 and includes that the noise is added to the frame at a layer mixer of a DPU.

Aspect 16 may be combined with any of aspects 1-15 and includes that at least one of a first brightness or a first chrominance of the noise differs from at least one of a second brightness or a second chrominance of at least the portion of the image.

Aspect 17 may be combined with any of aspects 1-16 and includes that the camera and the display device are included in a VR device, an AR device, or a MR device.

Aspect 18 may be combined with any of aspects 1-17 and includes that a lens of the camera and a surface of the display device are oriented towards a point in the environment when the image is captured.

Aspect 19 may be combined with any of aspects 1-18 and includes that the display device includes at least one display panel.

Aspect 20 may be combined with aspect 19 and includes that the frame including the noise is overlaid on the image of the environment when displayed on the at least one display panel.

Aspect 21 may be combined with any of aspects 1-19 and includes that the display device includes at least one transparent surface or at least one semi-transparent surface.

Aspect 22 may be combined with aspect 21 and includes that the frame is displayed on the at least one transparent surface or the at least one semi-transparent surface.

Aspect 23 is an apparatus for display processing including at least one processor coupled to a memory and configured to implement a method as in any of aspects 1-22.

Aspect 24 may be combined with aspect 23 and includes that the apparatus is a wireless communication device including at least one of an antenna or a transceiver coupled to the at least one processor, and where to obtain the frame, the at least one processor is configured to receive the frame via at least one of the antenna or the transceiver.

Aspect 25 is an apparatus for display processing including means for implementing a method as in any of aspects 1-22.

Aspect 26 is a computer-readable medium (e.g., a non-transitory computer-readable medium) storing computer executable code, the computer executable code when executed by at least one processor causes the at least one processor to implement a method as in any of aspects 1-22.

Various aspects have been described herein. These and other aspects are within the scope of the following claims.

What is claimed is:

1. An apparatus for display processing, comprising:
a memory; and
at least one processor coupled to the memory and, based at least in part on information stored in the memory, the at least one processor is configured to:
obtain an image of an environment captured by a camera and a frame that is to be displayed;
compute a first histogram based on the image and a second histogram based on the frame;
add noise to the frame based on the first histogram and the second histogram, wherein the noise is distinguishable from at least a portion of the image; and
transmit the frame including the noise for display on a display device.

2. The apparatus of claim 1, wherein the frame includes an object that is to be displayed on the display device, and wherein the at least one processor is further configured to:
determine at least one edge of the object, wherein to add the noise to the frame, the at least one processor is configured to add the noise to the at least one edge of the object included in the frame or around the at least one edge of the object included in the frame.

3. The apparatus of claim 1, wherein the at least one processor is further configured to:
compute a match factor based on the first histogram and the second histogram, wherein to add the noise to the frame, the at least one processor is configured to add the noise based on the match factor and at least one threshold value.

4. The apparatus of claim 3, wherein the first histogram comprises a first distribution of pixel values associated with the environment, and wherein the second histogram comprises a second distribution of pixel values associated with the frame.

5. The apparatus of claim 4, wherein the match factor is indicative of a closeness of the first distribution of the pixel values to the second distribution of the pixel values.

6. The apparatus of claim 3, wherein the at least one threshold value comprises a first threshold value and a second threshold value, wherein the first threshold value and the second threshold value define a range, and wherein to add the noise to the frame, the at least one processor is configured to add the noise to the frame based on the match factor being within the range.

7. The apparatus of claim 3, wherein the at least one processor is further configured to:
determine a strength of the noise based on a noise strength factor and an alpha noise value, wherein to add the noise to the frame, the at least one processor is configured to add the noise to the frame such that the noise includes the determined strength.

8. The apparatus of claim 7, wherein the at least one processor is further configured to:
obtain the alpha noise value; and
identify the noise strength factor based on the match factor and a lookup table (LUT), wherein the LUT comprises a plurality of match factors and a plurality of noise strength factors for the plurality of match factors.

9. The apparatus of claim 7, wherein the at least one processor is further configured to:
obtain an attenuation factor;
compute the noise strength factor based on the attenuation factor and at least one first value, wherein the at least one first value includes a value associated with a mean noise level; and
compute the alpha noise value based on the attenuation factor, the noise strength factor, and at least one second value, wherein the at least one second value includes the value associated with the mean noise level.

10. The apparatus of claim 3, wherein the at least one processor is further configured to:
determine a strength of the noise based on the match factor, wherein to add the noise to the frame, the at least one processor is configured to add the noise to the frame such that the noise includes the determined strength.

11. The apparatus of claim 1, wherein the at least one processor is further configured to:
add attenuation to the frame including the noise based on an attenuation factor.

12. The apparatus of claim 1, wherein the noise comprises dither noise.

13. The apparatus of claim 12, wherein to add the noise to the frame, the at least one processor is configured to add the dither noise to the frame further based on at least one dither matrix.

14. The apparatus of claim 1, wherein to obtain the frame that is to be displayed, the at least one processor is configured to receive the frame from a graphics processor.

15. The apparatus of claim 1, wherein to add the noise to the frame, the at least one processor is configured to add the noise at a layer mixer of a display processing unit (DPU).

16. The apparatus of claim 1, wherein at least one of a first brightness or a first chrominance of the noise differs from at least one of a second brightness or a second chrominance of at least the portion of the image.

17. The apparatus of claim 1, wherein the camera and the display device are included in a virtual reality (VR) device, an augmented reality (AR) device, or a mixed reality (MR) device.

18. The apparatus of claim 1, wherein a lens of the camera and a surface of the display device are oriented towards a point in the environment when the image is captured.

19. The apparatus of claim 1, wherein the display device comprises at least one display panel.

20. The apparatus of claim 19, wherein the frame including the noise is overlaid on the image of the environment when displayed on the at least one display panel.

21. The apparatus of claim 1, wherein the display device comprises at least one transparent surface or at least one semi-transparent surface.

22. The apparatus of claim 21, wherein the frame is displayed on the at least one transparent surface or the at least one semi-transparent surface.

23. The apparatus of claim 1, wherein the apparatus is a wireless communication device comprising at least one of an antenna or a transceiver coupled to the at least one processor, and wherein to obtain the frame, the at least one processor is configured to receive the frame via at least one of the antenna or the transceiver.

24. A method of display processing, comprising:
obtaining an image of an environment captured by a camera and a frame that is to be displayed;
computing a first histogram based on the image and a second histogram based on the frame;
adding noise to the frame based on the first histogram and the second histogram, wherein the noise is distinguishable from at least a portion of the image; and
transmitting the frame including the noise for display on a display device.

25. The method of claim 24, wherein the frame includes an object that is to be displayed on the display device, the method further comprising:
determining at least one edge of the object, wherein the noise is added to the at least one edge of the object included in the frame or around the at least one edge of the object included in the frame.

26. The method of claim 24, further comprising:
computing a match factor based on the first histogram and the second histogram, wherein the noise is added to the frame based on the match factor and at least one threshold value.

27. The method of claim 26, wherein the first histogram comprises a first distribution of pixel values associated with the environment, and wherein the second histogram comprises a second distribution of pixel values associated with the frame.

28. The method of claim 27, wherein the match factor is indicative of a closeness of the first distribution of the pixel values to the second distribution of the pixel values.

29. The method of claim 26, wherein the at least one threshold value comprises a first threshold value and a second threshold value, wherein the first threshold value and the second threshold value define a range, and wherein the noise is added to the frame based on the match factor being within the range.

30. A computer-readable medium storing computer executable code, the computer executable code when executed by at least one processor causes the at least one processor to:
obtain an image of an environment captured by a camera and a frame that is to be displayed;
compute a first histogram based on the image and a second histogram based on the frame;
add noise to the frame based on the first histogram and the second histogram, wherein the noise is distinguishable from at least a portion of the image; and
transmit the frame including the noise for display on a display device.
